(19) United States
(12) Patent Application Publication
(10) Pub. No.: US 2007/0140702 A1
(43) Pub. Date: Jun. 21, 2007

(54) Method and system for providing timing recovery in an optical system

(76) Inventors: Albert Hendrik Jan Immink, Eindhoven (NL); Bin Yin, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/582,577

(22) PCT Filed: Dec. 9, 2004
(86) PCT No.: PCT/IB04/52734

§ 371 Date: Jun. 12, 2006

(30) Foreign Application Priority Data
Dec. 15, 2003 (EP) 03104688.1

(51) Int. Cl. H04B 10/00

(52) U.S. Cl. 398/158

(57) ABSTRACT

The invention regards a new threshold crossing timing recovery scheme for use in high capacity optical disc systems. The timing error of a timing error detector is multiplied with a weighing function. This scheme effectively increases the robustness of the optical system against data-induced jitter, which is considered to be the dominant disturbance of the timing recovery as the capacity of the optical discs is high. The invention furthermore describes a number of examples of possible weighing functions.

### FIELD OF THE INVENTION

This invention relates to a method of providing threshold crossing timing recovery in an optical system, which optical system is adapted to read data samples from an optical disc, said method comprising the steps of reading data samples (ys) at a sampling time (ts) from the optical disc by means of the optical system; feeding the read samples to a timing recovery means; and adjusting the sampling time (ts) towards the synchronous timing instants (tk) on the basis of the timing error information (Ψk).

### BACKGROUND OF THE INVENTION

Optical discs are electronic data storage mediums that hold information in digital form and that are written and read by a laser in an optical system. These discs include all the various CD, DVD and BD variations. Data are stored in so-called pits and lands (ROM disc) and marks and spaces (re-writable disc), which are read by means of a laser in an optical system and the data are converted into an electrical signal.

In an optical system it is well known to use a threshold crossing timing recovery, where the sampling time is adjusted by comparing the actual threshold crossings with threshold crossings of a sampling clock signal. This timing recovery acquires the timing information from the incoming data itself and needs no aid from the bit decision, so that it is not hampered by decision errors. A special case of threshold crossing timing recovery is the zero crossing timing recovery, in that the threshold is set to zero due to the DC free feature of the binary bit sequence recorded on the disc. The zero crossing timing recovery is the recovery scheme usually employed in current high capacity optical discs, in that the data thereon typically are coded in RLL coding.

In timing recovery in an optical system, timing error information (Ψₖ) is determined. This timing error information (Ψₖ) will be zero in case of a noise free channel with, for example, a raised-cosine characteristic, as the data signal samples are synchronously sampled. However, the optical system is subjected to noise and can have a partial-response like channel, which result in the fact that, with bit synchronous sampling, only the mean value of the timing error information (Ψₖ) is zero, while it instantaneously is jittery. The jitter comprises noise-induced jitter and data-induced jitter. When the data on the disc are recorded in RLL coding, the zero crossing timing recovery suffers very weakly from data-induced jitter in a disc capacity of 23 GB or less.

Increasing the storage density on optical discs is a concern of great importance and attention. At present, it is known to try to reach higher storage densities by using more advanced signal processing, different modulation schemes (for instance multi-level techniques) or different physical principles (for instance super-resolution techniques), given the characteristics of the optical channel. However, as the disc capacity increases by means of narrowing the channel bit length, for example to 29 GB or above, the data samples around transitions (i.e. threshold crossings, e.g. zero crossings) cannot avoid Inter-Symbol Interference (ISI). The data-induced jitter gets so severe at disc capacities of 31 GB, due to the strong ISI, that threshold crossing timing recovery becomes unfeasible.

### OBJECT AND SUMMARY OF THE INVENTION

It is the object of the invention to provide a method of providing threshold crossing timing recovery in an optical system, where the impact of data-induced jitter is alleviated, especially in the case of high capacity optical discs.

This object is achieved, when the method of the opening paragraph is characterized in that it further comprises a step of multiplying the timing error information (Ψₖ) by a weighing function W in succession of the step of determining the timing error information (Ψₖ) and before the step of adjusting the sampling time (t₅) to the synchronous sampling time (tₖ). Hereby, a threshold crossing timing recovery, where the inter-symbol interference is minimized at high capacity optical discs, e.g. optical discs with a capacity of 29 GB or 31 GB, is achieved.

In a preferred embodiment, the threshold crossing timing recovery means is adapted to provide timing recovery to data signal samples coded in binary modulation. This is advantageous in that binary modulation is a widely used coding of data signals on optical discs.

Preferably, the weighing function W according to the invention is a function of sₖ=|(yₖ−yₖ₊₁)/(tₖ−tₖ₊₁)|, where yₖ and yₖ₊₁, respectively, are synchronized data signal samples and tₖ and tₖ₊₁, respectively, are synchronous sampling instants. This weighing function W(sₖ) can be applied to any signal coded by means of any binary modulation method. The function sₖ provides a simplified way to calculate the weighing function W(sₖ) as a function of the synchronized data signal samples. sₖ expresses the absolute value of the steepness of the data signal waveform around the threshold crossing. In zero crossing timing recovery sₖ also gives an indication of the signal energy around the transition, because yₖ and yₖ₊₁ always have opposite signs (in that a zero crossing takes place between them).

According to preferred embodiments of the invention, the weighing function W(sₖ) can be expressed as for example W(sₖ)=sₖ/sₘₐₓ, W(sₖ)=(sₖ/sₘₐₓ)², or W(sₖ)=exp [1−(sₖ/sₘₐₓ)⁻¹], where sₘₐₓ represents the maximum value of sₖ, i.e. the maximum steepness of the data signal waveform around all transitions. The choice between the different weighing functions relies on different disc capacities and the analysis of the corresponding data-induced jitter spectra.

In a preferred embodiment the timing recovery means is adapted to provide timing recovery to data signal samples coded in RLL(d) coding, where d stipulates the minimum run length in the data stream, i.e. it constraints the smallest number of consecutive ones or zeros in the stream to be (d+1).

Preferably, the threshold crossing timing recovery used in the method according to the invention is a zero crossing timing recovery. This is the threshold crossing timing recovery used when data are coded in RLL coding.

According to yet a preferred embodiment of the invention, the weighing function W is a function W(Tₘ, Tₘ₊₁), where the arguments Tₘ and Tₘ₊₁ are the two successive run lengths Tₘ and Tₘ₊₁, respectively, around a transition. According to a preferred example, the weighing function W(Tₘ, Tₘ₊₁) increases when the sum of Tₘ and Tₘ₊₁ increases. According to a preferred alternative example, the weighing function W(Tₘ, Tₘ₊₁) decreases when the numerical difference |Tₘ−Tₘ₊₁| between Tₘ and Tₘ₊₁ increases, since the data-induced jitter typically is more serious for a large difference between two successive run lengths than for smaller differences. W could be proportional to “Tₘ+Tₘ₊₁” and/or conversely proportional to |Tₘ−Tₘ₊₁| or nonlinearly dependent on “Tₘ+Tₘ₊₁” and/or |Tₘ−Tₘ₊₁|.

According to yet a preferred embodiment of the invention, the weighing function W(Tₘ, Tₘ₊₁) is zero if Tₘ equals “d+1” or Tₘ₊₁, equals “d+1”, where “d+1” is the shortest run length in the RLL coding. Hereby the transitions involving the shortest run length are skipped, which is advantageous in that those are the transitions most exposed to noise.

The invention will be explained more fully below in connection with a preferred embodiment and with reference to the drawing, in which:

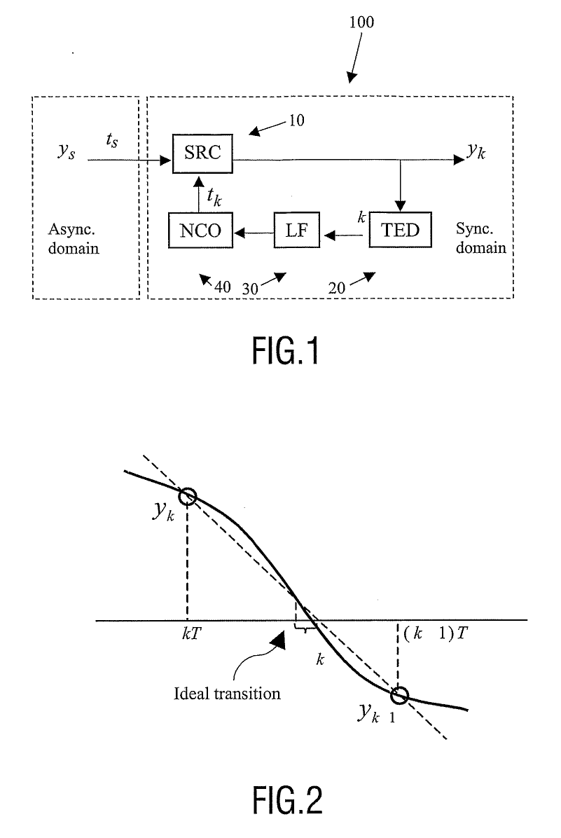

FIG. 1 shows a schematic drawing of a timing recovery means according to the prior art,

FIG. 2 shows a timing error detection in threshold crossing timing recovery,

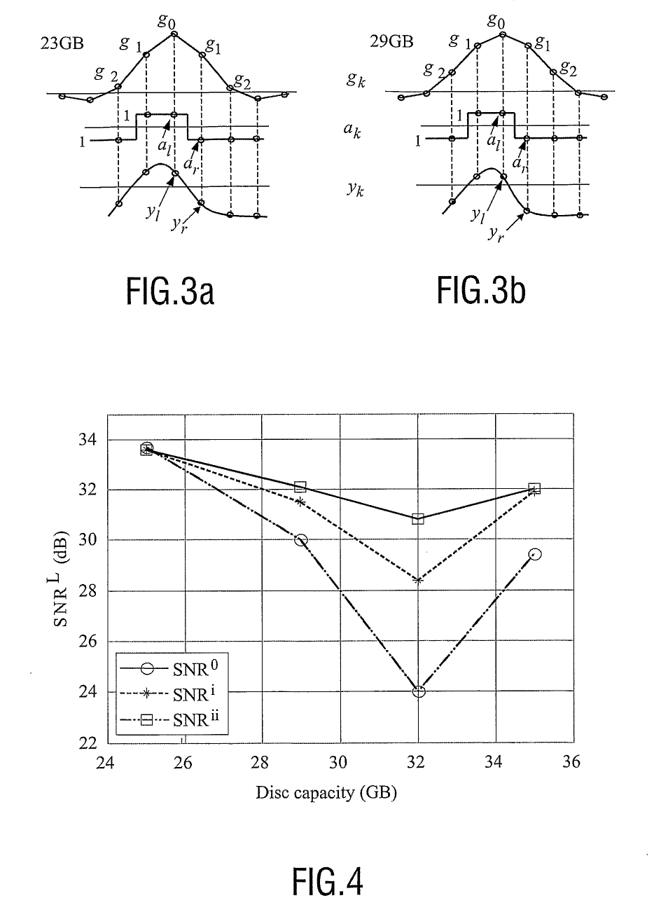

FIGS. 3a and 3b show disc readouts (prior art) in discs with the disc capacities 23 GB and 29 GB, respectively, and

FIG. 4 shows the timing recovery performance of the method according to the invention.

FIG. 1 shows a schematic drawing of a timing recovery means 100 according to the prior art. The timing recovery means 100 contains a sample rate converter SRC 10, a timing error detector (TED) 20, a loop filter LF 30 and a numerically controlled oscillator (NCO) 40. Data samples yₛ are read from an optical disc and are fed at sampling times tₛ to the timing recovery means 100. The numerically controlled oscillator 40 outputs to the sample rate converter the sampling clock tₖ that is updated on the basis of timing error information Ψₖ detected by the timing error detector 20. The timing recovery means 100 is fed with non synchronized data samples yₛ from the asynchronous domain upstream of the timing recovery means 100, and bit decisions are made on the synchronized data samples yₖ in the synchronous domain downstream of the timing recovery means 100.

FIG. 2 shows a timing error detection in threshold crossing timing recovery. In threshold crossing recovery of data signal samples recorded on an optical disc, the timing error information Ψₖ can be derived to the first order of approximation as shown in FIG. 2. In FIG. 2 the horizontal line indicates the threshold, and it can be seen that a first order of approximation of the timing error information Ψₖ is derived as:

$${ψ}_{k} = \frac{{y}_{k}}{{y}_{k} - {y}_{k - 1}} - \frac{T}{2} . \qquad ( 1 )$$

In the case of a noise-free channel with, for example, a raised-cosine characteristic, Ψₖ will approach zero as the data signal is synchronously sampled. However, the optical channel is subject to different types of noise and normally of a partial-response type, which result in the fact that with bit synchronous sampling only the mean value of Ψₖ is zero while it remains instantaneously jittery due to noise-induced jitter and data-induced (or pattern dependent) jitter.

With the help of binary modulation in general and run length limited (RLL) coding in specific the data induced jitter can be alleviated. This is illustrated in FIGS. 3a and 3b, which show disc readouts (prior art) in discs with the disc capacities 23 GB and 29 GB, respectively for RLL (d) coding with d=1 in Blu-ray disc format. It is assumed that the optical channel is linear and partial response like. The threshold crossing timing recovery is a zero crossing timing recovery in this case, in that the binary modulation is a RLL coding. In FIGS. 3a and 3b the signal samples yₖ read from the disc equals an input binary bit sequence aₖ, convolved with the equalized channel response gₖ, i.e. yₖ=(g (g [symbol] a)ₖ.

Omitting the taps of low amplitude in gₖ, the sample yᵢ to the left of the transition can be approximated to be:
yᵢ≈g₀·a₁+g₋₁·a₁₋₁+g₁·aᵣ+g₋₂·a₁₋₂+g₂·aᵣ₊₁ (2)

In the case of 23 GB disc capacity, the side taps g₋₂ and g₂ are negligible in magnitude; moreover, the bits around a₁ always have opposite signs due to the constraint of the coding with d=1. Therefore all other contributions to the approximation of y₁ than the first term of (2) are set to zero, so that the equation (2) can be simplified to:
y₁=g₀·a₁ (3)

Equation (3) implies that the sample y₁ is free of inter-symbol interference. This holds for the sample yᵣ as well. Thus, the zero crossing timing recovery suffers very weakly from data-induced jitter in the capacity of 23 GB; this is due to the RLL coding.

FIG. 3b shows the disc readout in a disc with the disc capacity 29 GB. A disc with a capacity of 29 GB is more exposed to ISI than a disc with the disc capacity of 23 GB as will be explained below; this is due to the narrowed channel bit length. Since the bits around a₁ always have different signs and g₋₁ and g₁ are of same magnitude and sign, the terms including g₋₁ and g₁ in equation (2) nullify each other, so that in case of FIG. 3b, the equation (2) can be expressed as:
y₁≈g₀·a₁+g₋₂·a₁₋₂+g₂·aᵣ₊₂ (4)

However, the side taps g₋₂ and g₂ of the equalized channel response gₖ are raised and cannot be assumed to be negligible. Thus the inter-symbol interference or data-induced jitter exists again in the timing recovery.

Disc capacities can now exceed the 29 GB of FIG. 3b, currently going up to 35 GB; thus, the channel bit length is reduced even further compared to FIG. 3b and data-induced jitter becomes severe due to the strong ISI, making traditional zero crossing timing recovery unfeasible.

FIG. 4 shows the timing recovery performance of the method according to the invention with various weighing factors and as a function of disc capacity. A simulation has been executed on the structure in FIG. 1 with data generated by a scalar diffraction program. The data is synchronous and noise free and used as input yₘ to the timing recovery means. To evaluate the performance of the timing recovery, a signal-to-noise ratio SNR^{L} is defined as:

$${SNR}^{L} = 20 log \frac{‖ {y}_{k}^{*} ‖}{‖ {y}_{k}^{L} - {y}_{k}^{*} ‖} , L = 0 , i , ii \qquad ( 5 )$$

where yₖ^{*} represents the output of the SRC of the timing recovery means 100 (FIG. 1) with ideal sampling times and yₖ^{L} represents the actual samples output from the SRC when the timing recovery scheme is running. The superscript L indicates the type of weighing function used in the TED.

In equation (5) “L=0” indicates a weighing function W(sₖ)=1 (i.e. the timing error remains unchanged); “L=i” indicates a weighing function W(sₖ)=sₖ/sₘₐₓ, and “L=ii” indicates a weighing function W(sₖ)=(sₖ/sₘₐₓ)².

Since no noise is present in the simulation, SNR^{L} can evaluate the robustness of the timing recovery scheme against data-induced jitter. The initial sampling frequency is given a 10% mismatch when the timing recovery starts to run. The loop bandwidth and damping have been adjusted properly in order to make it as uniform as possible under various weighing functions W(sₖ), so that SNR^{L} can be compared directly for different weighing functions. FIG. 4 shows SNR^{L} for high capacity discs of the BD type at the capacities 25 GB, 29 GB, 32 GB and 35 GB. The data window includes the first 5000 samples to take the transient performance into account.

It can be seen that the performance of the timing recovery is effectively improved with the help of the weighing function different from unity. The improvement becomes more obvious as the capacity increases due to the more sever data-induced jitter. Overall, the non-linear weighing function (type ii) has a better performance than the linear weighing function (type i) or the unity weighing function (type 0). In the capacity of 32 GB the improvement is about 7 dB compared to the unity weighing function. The value of SNR^{L} at 35 GB is increased relative to the value of SNR^{L} at 32 GB, because the shortest run length suffering mostly from ISI, has no zero crossings, thus alleviating the data-induced jitter to some extent. Of course, the timing recovery efficiency decreases due to less zero crossings.

1. A method of providing threshold crossing timing recovery in an optical system, which optical system is adapted to read data signal samples from an optical disc, said method comprising the steps of
reading data signal samples (ys) at a sampling time (ts) from the optical disc by means of the optical system,
feeding the read data signal samples (ys) to a timing recovery means,
determining timing error information (Ψk) by means of the timing recovery means,
adjusting the sampling time (ts) towards the synchronous timing instants (tk) on the basis of the timing error information (Ψk),
characterized in that the method further comprises a step of multiplying the timing error information (Ψk) by a weighing function W in succession of the step of determining the timing error information (Ψk) and before the step of adjusting the sampling time (ts) towards the synchronous timing instants (tk).

2. A method according to claim 1, characterized in that the timing recovery means is adapted to provide timing recovery to data signal samples coded in binary modulation.

3. A method according to claim 1, characterized in that the weighing function W is a function of sk=|(yk−yk+1)/(tk−tk+1)|, where yk and yk+1, respectively, are synchronized data signal samples and tk and tk+1, respectively, are synchronous sampling instants.

4. A method according to claim 3, characterized in that W(sk)=sk/smax, where smax represents the maximum value of sk.

5. A method according to claim 3, characterized in that W(sk)=(sk/smax)2, where smax represents the maximum value of sk.

6. A method according to claim 3, characterized in that W(sk)=exp [1−(sk/smax)−1], where smax represents the maximum value of sk.

7. A method according to claim 1, characterized in that the timing recovery means is adapted to provide timing recovery to data signal samples coded in RLL(d) coding.

8. A method according to claim 1, characterized in that the threshold crossing timing recovery is a zero crossing timing recovery.

9. A method according to claim 7, characterized in that the weighing function W is a function W(Tm, Tm+1), where the arguments Tm and Tm+1 are the two successive run lengths Tm and Tm+1, respectively, around a transition.

10. A method according to claim 9, characterized in that the weighing function W(Tm, Tm+1) increases when the sum of Tm and Tm+1 increases.

11. A method according to claim 8, characterized in that the weighing function W(Tm, Tm+1) decreases when the numerical difference |Tm−Tm+1| between Tm and Tm+1 increases.

12. A method according to claim 8, characterized in that the weighing function W(Tm, Tm+1) is 0, if Tm equals “d+1” or if Tm+1 equals “d+1”, where “d+1” is the shortest run length in the RLL coding.

13. An optical system for reading data stored on high capacity optical disc, characterized in that the optical system performs a method according to claim 1.
